(19) United States
(12) Patent Application Publication
(10) Pub. No.: US 2007/0022141 A1
(43) Pub. Date: Jan. 25, 2007

(54) System and method for acquiring and assembling real property data

(76) Inventors: Shawn D. Singleton, Murrieta, CA (US); Mark A. Werner, Carlsbad, CA (US)

Correspondence Address: SNELL & WILMER LLP, 600 ANTON BOULEVARD, SUITE 1400, COSTA MESA, CA, 92626, US

(21) Appl. No.: 11/477,338

(22) Filed: Jun. 29, 2006

Related U.S. Application Data
(60) Provisional application No. 60/700,962, filed on Jul. 19, 2005.

(51) Int. Cl. G06F 7/00

(52) U.S. Cl. 707/104.1

(57) ABSTRACT

A method and apparatus for acquiring property data from numerous property information sources and assembling the data in a standard format. For each source there is at least one custom dynamic interface for retrieving and standardizing the property data. A custom dynamic interface is capable of dynamically reacting to changes made in the sources of property information by parsing data and selecting only information relevant to a data request. The method and apparatus may receive multiple requests for property data from individual users and automated systems, and respond to the requests in real time or store standardized records for later delivery. The apparatus includes a server interfacing with the sources and requesters via a network, and memory containing multiple custom dynamic interfaces, and all software modules required to receive and prioritize requests, determine sources appropriate for the requests, access the sources using authentication, and retrieve, format, and store the requested data.

### CLAIM OF PRIORITY UNDER 35 U.S.C. §119

The present Application for Patent claims priority to Provisional Application No. 60/700,962 entitled “METHOD AND APPARATUS FOR COMPILING AND ASSEMBLING PROPERTY DATA,” filed Jul. 19, 2005, and assigned to the assignee hereof and hereby expressly incorporated by reference.

### BACKGROUND

1. Field

The present invention relates to real property data acquisition and more specifically to a system and method for acquiring and assembling data on real property. Using computer hardware and/or software, the present invention is capable of interfacing with any number of property data servers or services, acquiring relevant real property data and organizing the real property data received into a uniform format.

2. Background

Public records data about real property, particularly property located in the United States, is generally available to the public via the Internet. In the United States, real property data is typically maintained and administered by county governments within each state. Although virtually every county allows such data to be accessed electronically, data storage, collection, and retrieval methods are not standardized. Each county maintains its own public records system, and each system may require that database access be controlled according to procedure specific to that county's system. Some require secure login steps, while others are open to all. The data available from one system may or may not be available on a different system. Some systems provide all data on one web page while others have multiple pages or frames. These and other differences among the many real property data systems exist in the prior art.

Historically, most public records data pertaining to properties is accessed by manual data entry. In other words, a user would utilize a login to a particular web-enabled database and would then manually enter the data required by the system to access additional data about a property. The data received may then be entered into another application product on the user's computer or may be manually written down to be added to a local database by another user. This process is time-consuming and may lead to data entry errors. Software or system upgrades create further problems. Over time, public information systems tend to change the format in which information is presented, and may also change the type of information that may be accessed. Each time the format and/or content of the information system changes, the individuals responsible for accessing data from that system must be retrained.

### SUMMARY

A system and method is provided to help alleviate retraining costs, to interface directly with the numerous public information databases, to provide a single interface whereby public information pertaining to properties may be obtained, and to automate the process more effectively. A system and method is provided that may quickly adapt to the changing interfaces of the numerous public information systems and that may provide seamless access, despite any changes to the underlying public information systems being accessed.

A system and method is provided where data may be extracted from any public information database using one of many modules designed for interfacing with public information databases. The data may be standardized and stored in a database for access by the user or requester of the data. The system provides a single point of contact for data requests, and automates the underlying process of logging into a particular public information database and accessing the relevant data using steps and available data input modules.

The system and method provides a means to utilize a computer as the intermediary and the receiver of the data. The system and method eliminates user data input error, eliminates retraining costs, and provides a standard interface for individuals seeking public information pertaining to a property. The system and method accesses data automatically upon request, utilizing modules designed for each public information access system, thereby providing a single interface for users.

An object of the present invention includes collecting public information about properties from numerous sources. It is another object of the present invention to utilize a single interface for requesting public record information about properties. It is another object of the present invention to standardize data received from numerous public information systems into a standard format and to store the data for easy access. It is a further object of the present invention to provide a user or requester with access to this public information system data in real time. These and other objects will be or will become apparent in the following detailed description of the present invention.

### BRIEF DESCRIPTION OF THE DRAWINGS

The features, objects, and advantages of the present invention will become more apparent from the detailed description set forth below when taken in conjunction with the drawings, wherein:

FIG. 1 is a block diagram of a data acquisition system showing a data acquisition server and memory for acquiring and assembling property data according to an embodiment of the present invention.

FIG. 2 is a block diagram of a plurality of custom design interface modules of a dynamic library in the memory shown in FIG. 1 according to an embodiment of the present invention.

FIG. 3 is a lookup table in the memory shown in FIG. 1 that cross-references property information sources to custom dynamic interface modules according to an embodiment of the present invention.

FIG. 4 is a block diagram of a plurality of software sub-modules contained within a particular custom design interface module according to an embodiment of the present invention.

FIG. 5 is a flow chart of a method for acquiring, filtering and assembling property data according to an embodiment of the present invention.

### DETAILED DESCRIPTION

The system and method compile and assemble property data. The system and method utilize computer software, hardware and combinations thereof to standardize the request for property data from public information databases, receive the property data, standardize the property data, and provide the property data in real time to the requester. The system and method automate an otherwise difficult and time-consuming manual process.

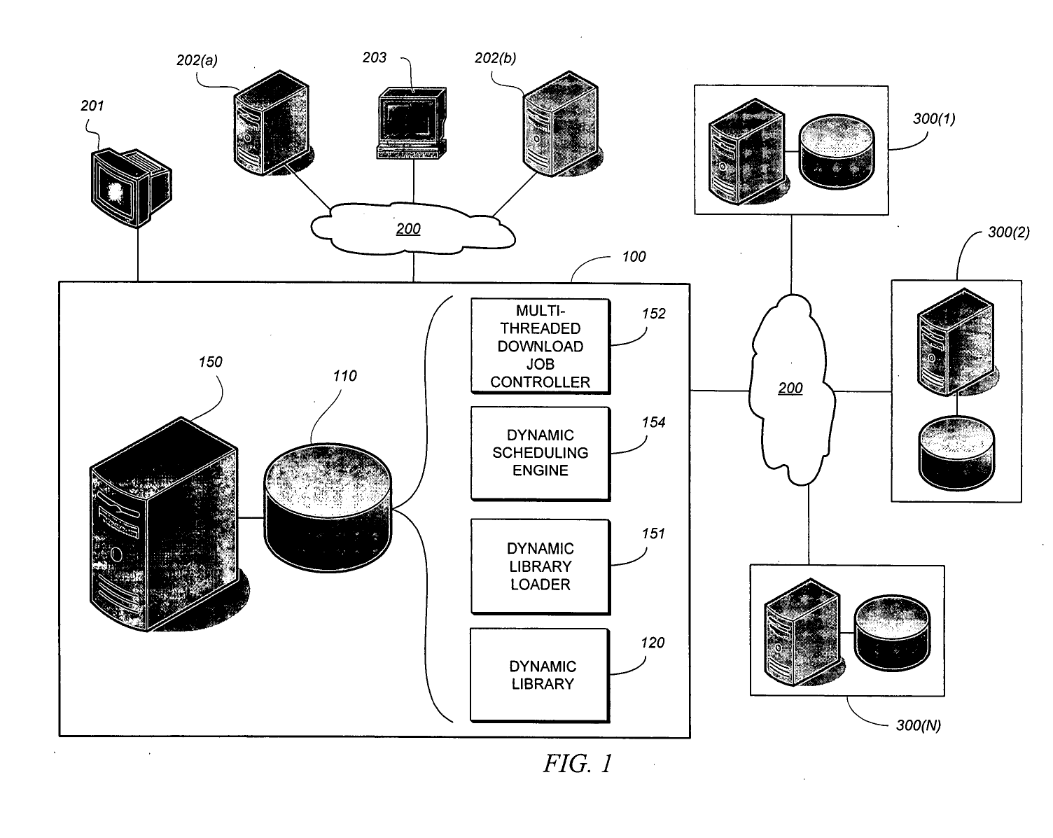

FIG. 1 is a block diagram of a data acquisition system 100 showing a data acquisition server 150 and memory 110 for acquiring and assembling property data. The data acquisition system 100 may include the data acquisition server 150 and the memory 110. The memory 110 may store the software modules associated with the present invention. The memory 110 may be any computer-accessible memory known in the art and capable of storing one or more software modules, for example, hard disk, floppy disk, CD-ROM, flash memory, RAM, ROM, EEPROM, and the like. The software modules may be created using hard coding techniques, i.e., by designing electronic components to perform the various functions.

The data acquisition server 150 may be any computer system capable of operating on a network and managing network resources and may exist on a multiprocessing operating system. The data acquisition server 150 may be a desktop computer such as a PC or Macintosh, running an appropriate operating system such as Windows, Mac OS, UNIX, FreeBSD, Solaris, LINUX, or equivalent. The data acquisition server 150 processes data requests from one or more users that may provide requests from one or more systems 201, 202 and 203.

In response to the data requests, the data acquisition server 150 gathers data from numerous property information sources, such as 300(1), 300(2), and/or 300(N). The software modules stored in the memory 110 may be executed by the data acquisition server 150 to allow the data acquisition server 150 to perform these and other functions. For illustrative purposes, three property information sources (e.g., public information systems) 300(1), 300(2), and 300(N) are shown. However, it shall be appreciated that the data acquisition server 150 is capable of communicating with an indefinite number of such systems via the network 200, as indicated by the symbol N, which represents any integer.

The network 200 represents any communications network enabling data transmissions between or among a plurality of computers, such as a local area network, wide area network, or the Internet. For example, public records of real property transactions are typically available to the public via the Internet through a secure connection on a read-only basis. Secure access for updating records is administered by the government agency responsible for maintaining the databases, and such access may be confined to local networks within the agency. The network 200, as shown in the figure, represents any of these configurations.

Requests or queries for property data to be retrieved by the acquisition server 150 may be initiated by various user interfaces. One such interface may be a local access point 201, which may query the data acquisition server 150 directly, without communicating via a network link such as network 200. The local access point 201 may be a user interface such as a computer terminal equipped with a keyboard or other input device, capable of sending a request to the data acquisition server 150, and capable of receiving information retrieved by the data acquisition server 150 in response to the request.

Another user interface may be one or more client access points 203. The client access points 203 may provide a user interface to the data acquisition server 150 from a remote location via the network 200. For example, a client access point 203 may be a desktop computer located in a real estate office, or in a home or other business environment. Queries originating from a local access point or a client access point 203 may be low-volume queries. In one embodiment, a low-volume query is any single request for property data pertaining to a single property. For example, a real estate agent seeking a description of real property contained in a recorded transfer of title may issue a low-volume request for a single record that contains the desired information. Another example of a low-volume request may be any request made through a search engine responsive to input by a user interface such as a keyboard or mouse.

Another type of user interface capable of querying the data acquisition server 150 may be a live delivery system. In FIG. 1, two such systems are shown as live delivery system 202(a) and live delivery system 202(b); however, an infinite number of live delivery systems are possible. A live delivery system may be a remote computer system capable of issuing automated high-volume queries to the data acquisition server 150 via the network 200. In one embodiment, a high-volume query may be any automated or periodic request for multiple property records. An example of a high-volume query may be one that requests a list of assessed values of single family homes sold within a particular time period within a particular geographic region within a county. Another example of a high-volume query may be a request for properties owned by a common entity, where the request spans multiple counties. In this case, an acquisition server 150 may need to access multiple property information sources to fulfill the request. Another example of a high-volume query may be a periodic request for all new records recorded within a defined geographic region since the expiration of the previous period.

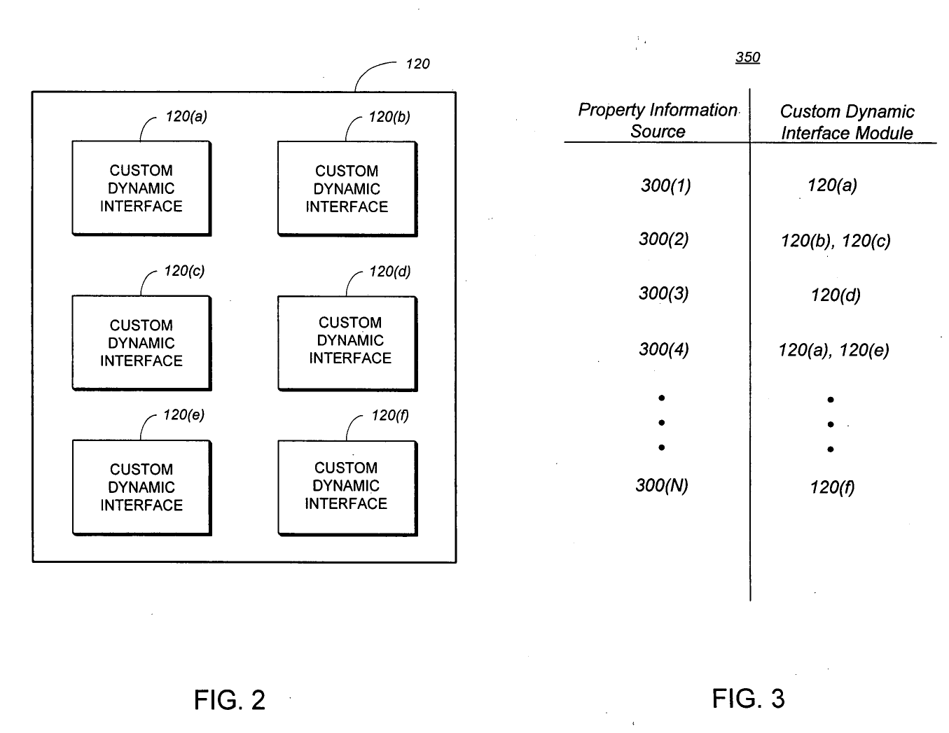

During operation of the data acquisition system 100, the data acquisition server 150 may determine which particular software modules are available for loading from a dynamic library 120. The dynamic library 120 contains a finite number of such software modules, or custom dynamic interface modules. These are depicted in FIG. 2, which shows as an example, six custom dynamic interface modules 120(a), 120(b), 120(c), 120(d), 120(e) and 120(f), available for uploading from the dynamic library 120. Each of the custom dynamic interface modules contains instructions for interfacing with a particular one or class of property information sources 300. By maintaining an up-to-date library of custom dynamic interface modules, the data acquisition server 150 may be provided with a means for interfacing with any property information source 300 available via the network 200. If there are any changes to formats, procedures or protocols for gaining access to a particular property information source 300, the corresponding custom dynamic interface module may be updated and stored in the dynamic library 120, so that the custom dynamic interface may continue to perform its main function of interfacing with the property information source. Therefore, the custom dynamic interface modules 120 may be changed over time to accommodate new circumstances. In addition, new custom dynamic interface modules may be stored in the dynamic library 120 portion of the memory 110 as desired. There may be numerous custom design interface modules available in the dynamic library 120, preferably at least one module for every property information source (or class of sources) to which the system is designed to interface with.

FIG. 3 is a lookup table 350 in the memory 110 shown in FIG. 1 that cross-references property information sources to custom dynamic interface modules. The lookup table 350 may be in any form and may be accessible by the data acquisition server 150 for associating each accessible property information source with one or more custom dynamic interface modules that enable the data acquisition server 150 to properly interface with the property information source. In the lookup table 350, the property information source 300(1) may be accessed using the custom dynamic interface module 120(a). The property information source 300(2) cross-references to custom dynamic interface module 120(b) and 120(c). This indicates that the custom dynamic interface 120(b) and/or the custom dynamic interface 120(c) may enable the data acquisition server 150 to access property information source 300(2). Also, the property information source 300(3) cross-references to the custom dynamic interface module 120(d), and the property information source 300(4) cross-references to the custom dynamic interface module 120(a) and/or the custom dynamic interface module 120(e). The data acquisition server 150 has no restriction on the total number of custom dynamic interface modules that may interface with any one property information source, and any one custom dynamic interface module may interface with one or more property information sources.

Referring to FIGS. 1 and 2, any of the available custom dynamic interface modules 120(a)-120(f) may be executed by the data acquisition server 150 in order to access a particular property information source 300(1)-300(N). Each custom dynamic interface module 120(a)-120(f) may be loaded using a dynamic library loader 151. To load the modules, the data acquisition server 150 may determine which modules are available in the memory 110. Once the available modules have been identified, the data acquisition server 150 may load the identified modules using the dynamic library loader 151. In one embodiment, the data acquisition server 150 may compare the current custom dynamic interface modules already loaded into the dynamic library 120 with the custom dynamic interface modules available in the memory 110. Any custom dynamic interface modules available in the memory 110 but not loaded into the dynamic library 120 may then be loaded using the dynamic library loader 151. The dynamic library loader 151 enables the data acquisition server 150 to add modules as more are created and to substitute new modules in place of older versions to interface with newly-changed property information sources 300. Once the modules are loaded, the data acquisition server 150 creates or updates the lookup table 350, which contains a list of the available property information sources 300 that may be accessed using the available modules. In one embodiment, the lookup table 350 may be stored as an index file within the dynamic library loader 151.

In the data acquisition system 100, requests or queries for property data originate from the user interfaces 201, 202 and 203. If the request originates from a live delivery system, such as 202(a) or 202(b), the request may be an automated request for the property data on numerous properties in order to populate the database. In some embodiments, such an automated request may be a periodic high-volume request for updating a remote database accessible by the live delivery system. Alternatively, if the request originates from the client access point 203, the request may include a low-volume request, typically made by a human user operating from a PC or similar workstation. In the latter case, the low-volume request for data acquisition may be made individually, or in small groups by manually inputting each request including the low volume, via a TCP/IP connection from the client access point 203 to the data acquisition server 150. In this scenario, the request may be made by running software on the client access point 203 that is capable of accessing the data acquisition server 150 via the network 200.

User interface requests via the network 200 to the data acquisition server 150 may be accepted by a multi-threaded download job controller 152. The multi-threaded download job controller 152 may be a software module that receives multiple incoming data requests. Upon receiving a data request, the multi-threaded download job controller 152 may forward relevant information extracted from the request on to a dynamic scheduling engine 154. In one embodiment, the relevant information may include indicia of a specified property information source known to contain or likely to contain the information requested. In another embodiment, the relevant information may include indicia of the type of user interface making the request.

The multi-threaded download job controller 152 also may allocate and send jobs to the dynamic scheduling engine 154 based upon pre-defined rules. For example, if the multi-threaded download job controller 152 receives a high-volume request from a live delivery system 202 performing an automated database update while simultaneously receiving a low-volume request for property information from a client access point 203, the multi-threaded download job controller 152, if rules are so defined, may forward the low-volume property data request first. In this embodiment, the low-volume requests made by human users may be fulfilled quickly and in real-time for the user's convenience, while fulfillment of the high-volume automated requests invisible to users may be completed with lower priority.

The dynamic scheduling engine 154 may be a software module used to request property data from the relevant property information source 300(1), 300(2) . . . and/or 300(N). The dynamic scheduling engine 154 determines whether the specified property information source is available. If so, the dynamic scheduling engine 154 connects the data acquisition server 150 to the specified property information source through execution of one or more custom dynamic interface module(s) 120(a), 120(b), 120(c), 120(d), 120(e) and/or 120(f) that cross-reference to the specified property information source. When the specified property information source(s) 300(1), 300(2) . . . and/or 300(N) are not available, the dynamic scheduling engine 154 may schedule requests for property data to be fulfilled at a later time. Each dynamic custom interface module 120(a)-120(f) may contain information required to connect to, and retrieve information from, a corresponding property information source 300(1)-300(N). In one embodiment, a dynamic custom interface module may include software for connecting to the property information source, software for receiving requested data, software for processing data received, software for receiving and processing images, and software for standardizing data before it is sent back to the dynamic scheduling engine 154. In alternative embodiments, some of the foregoing software may be removed and/or additional software may be added.

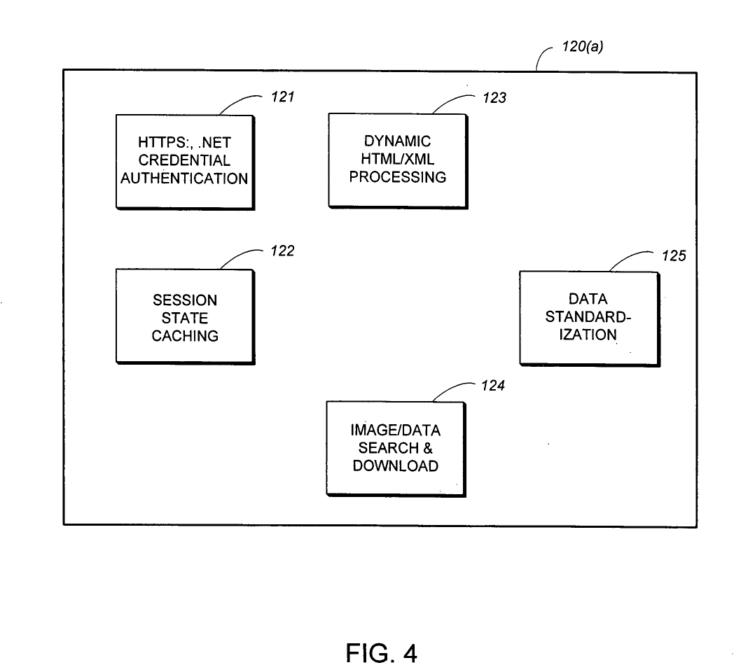

FIG. 4 is a block diagram of a plurality of software sub-modules contained within a particular custom design interface module. The components of this module may include a HTTPS:--.NET credential authentication module 121, a session state caching module 122, a dynamic HTML/XML processing module 123, an image/data search and download module 124 and a data standardization module 125.

The credential authentication module 121 is used for authentication when a login request is made to the property information source 300(1), 300(2) . . . or 300(N). Some form of authentication is usually required, and the credential authentication module 121 may perform the authentication process. The precise form of the authentication process depends on the property information source to which the data authentication server 150 is being connected. Some authentication may require usernames and passwords, while others may require a secure socket layer to be used for transmitting data. Thus, the authentication process (or processes) included within the custom dynamic interface module 120(a) accounts for the requirements of the particular property information source(s) to which it interfaces.

The session state caching module 122 stores any online property information source 300(1), 300(2) . . . or 300(N) certifications that may be required by the credential authentication 121 to effect two-way communication between the data acquisition system 100 and the property information source 300. Thus, the data contained within the session state caching module 122 may be changed or updated, as necessary, to maintain the required certifications current.

The dynamic HTML/XML processing module 123 may be responsible for parsing communications from the property information source 300(1), 300(2) . . . or 300(N). Typically, the property data received from the property information source is in the form of a dynamically generated web-page written in HTML or XML language. Therefore, the custom dynamic interface module 120(a) may utilize the dynamic HTML/XML processing module 123 to process the data being provided by the property information source 300. The dynamic HTML/XML processing module 123 has the capability of determining whether HTML/XML pages have changed in order to extract requested data there from. The dynamic HTML/XML processing module 123 may also determine what paths exist in the property information source 300 for accessing the requested data and any associated images, and passes this information on to the image/data search and download module 124.

The image/data search and download module 124 may request data and images of the property using the dynamic HTML/XML processing module 123. The data downloaded may be in any form. In one embodiment, at a minimum, text concerning the property, in database, tabular or other textual form, along with images in numerous formats may be downloaded. The data may be downloaded using filters to extract relevant data from data that is irrelevant to the request. The filtered data is then forwarded on to the data standardization module 125. The data standardization module 125 is responsible for formatting the data and images that have been downloaded so that they are ready to be stored in a standard format. In one embodiment, the data standardization module 125 is capable of performing validity checks on the data and of handling numerous types of data. Once the data has been standardized, the data may be forwarded on to the dynamic scheduling engine 154 to be returned to the requester or the user interface for display and/or storage in a database.

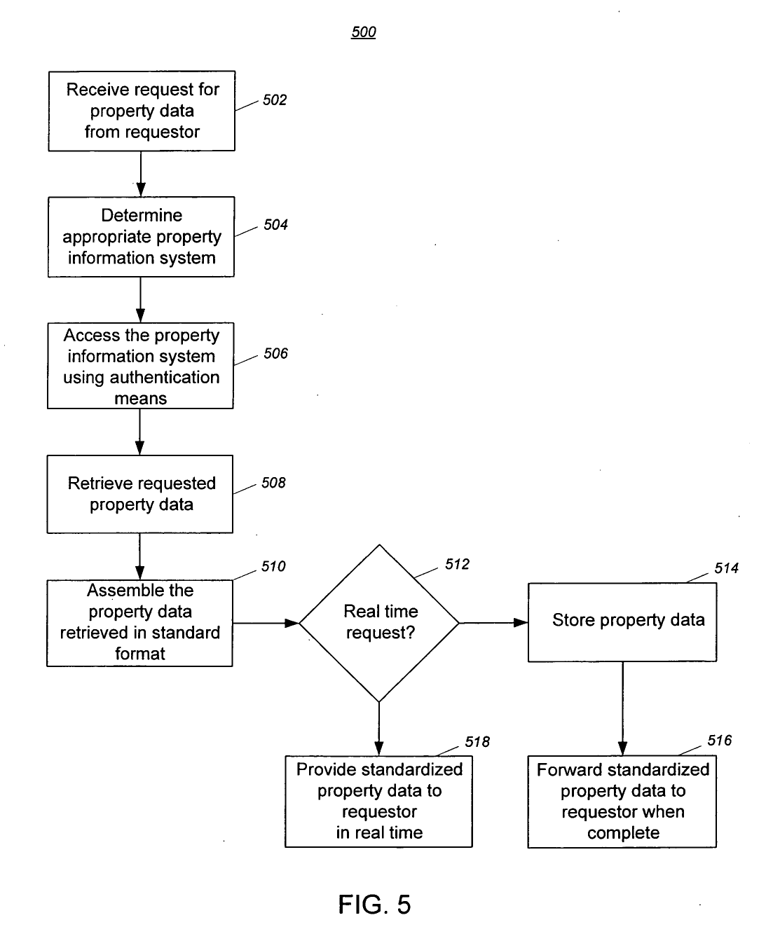

FIG. 5 is a flow chart of a method 500 for acquiring, filtering and assembling property data. In step 502, the property data requested through the user interface is received by the data acquisition server 150. In the request, all data necessary to identify the property for which data is being requested may be input by the user. Such information may include a property address, an APN number or other descriptive indicia, such as the type of the user interface making the request. In step 504, the data received is analyzed to determine the appropriate property information source(s) likely to fulfill the request. The data pertaining to a particular property may only be available on one or a few property information sources. The information may be a zip code or other recognizable property indicia to determine which property information source may be capable of providing the requested data. This decision may be made by the dynamic scheduling engine 154 cross-referencing the indicia to a database of available property information sources stored in the memory 110 and determining whether the property information source likely to contain the requested data is available.

In step 504, the appropriate custom dynamic interface module 120(a)-120(f) for use in accessing the particular property information source is also selected. The selected custom dynamic interface module may be one that is both capable of accessing the desired information and able to communicate with a property information source that is available for data communications. In some cases, there may be multiple custom dynamic interface modules which may be used for accessing a particular property information source, each of which is capable of gathering different limited portions of the total available data. Additionally, as modules are updated, a new module may be selected instead of an older one for a particular piece of newly-available information, where the older module may be useful for gathering different information such as historical information.

Referring now to all FIGS., once the appropriate property information source and the custom dynamic interface module are selected, the data acquisition server 150 uses the selected custom dynamic interface module to access one or more property information sources. To do so, the data acquisition server 150 accesses or connects to one or more property information sources (step 506). Access may require authentication of some type, the storage of a password, and a cookie or some other key, such as an encryption key, be saved in the memory 110 of the data acquisition server 150. Step 506 may be performed using the HTTP:--.NET credential authentication module 121 and/or the session state caching module 122.

In step 508, the data acquisition server 150 retrieves the requested property data and utilizes the module or modules selected from among 120(a)-120(f) that are appropriate to the particular property information source(s) 300(1), 300(2) . . . and/or 300(N) being accessed. The module selected from among 120(a)-120(f) may be used to request the appropriate data in the manner required by the particular property information source. The selected module may also be designed to accept data and to parse a response, filtering out relevant information from extraneous information. Typically, responses from an individual property information source may be coded in HTML (Hypertext Markup Language) or XML (Extensible Markup Language). The selected module may remove headers and irrelevant information from the responses of the property information source and download relevant data pertaining to the request.

In step 510, the data acquisition server 150 may assemble the property data received in step 508 in a standard format. In step 510, the data may be filtered or parsed from the responses of the property information source and may be organized according to a structure implemented in a standard database in which the data may be destined for storage. The same data may also conform to a format used for responding to the request. In one embodiment, a decision block 512 may be executed by the data acquisition server 150. In block 512, the data acquisition server 150 may determine whether the request is a real-time request originating from a local access point 201 or a client access point 203. If the request is a real-time request, i.e., a low-volume request made by a user expecting a quick response in real time, the relevant data retrieved may be formatted appropriately and then forwarded directly to the requesting access point in step 518.

If, on the other hand, the data acquisition server 150 determines that the request is not a real time request, i.e., the request is a high-volume request originating from a live delivery system 202(a) or 202(b), once a portion of the requested property data has been formatted and standardized, step 514 is performed. In step 514, the portion of the formatted and standardized data may be stored in the memory 110 of the data acquisition server 150. In one embodiment, the data, including partial fulfillment of a high-volume request that is taken from a property information source, may be stored in a standard format, to be appended with additional formatted and standardized data responsive to the request as it arrives. The arrival of partial requests may be delayed, for example, due to the dynamic scheduling engine 154 assigning higher priority to low-volume real time requests. Thus, the sum total of responsive data accumulates until complete, and is stored in the memory 110 for later forwarding to the requester as a complete response in step 516. All data received is preferable stored in the standardized format, despite any peculiarities of the data received by each custom dynamic interface module needed to fulfill the request. Standardization of the data advantageously enables fast searching, enables the requestor to more quickly recognize trends, and facilitates further manipulation or analysis of high-volume data using additional software or individual labor.

In step 518, method 500 provides the property data in real time. In one embodiment, this step may be considered optional. In one embodiment, two options may be used. Users of computers may issue high-volume requests for large blocks of information concerning a large set of properties. This type of request may or may not require real time fulfillment. The data collected for these block requests may simply need to be fulfilled in the next 24 hours, the next week, or in some other time period. Alternatively, the high-volume request may need an immediate response, and may need to be fulfilled in real time or as quickly as possible. In another embodiment, a low-volume request may pertain to a single or a small group of properties. These types of requests may largely be requests for data in real time; however, a requester may manually input a series of low-volume requests, and specify that a response be provided either in real time as partial data becomes available, or all at once when the series of requests are complete. So, for example, if the requestor requires property data pertaining to thirty properties and desires to have responses from the data acquisition system 100 as soon as data is available, the requestor may specify that the data be provided record by record in real time. Alternatively, if the requestor so desires, the requester may specify that the data be provided in a single report. In this case, the data may be temporarily stored and appended as in step 514 until complete, then a single report may be provided for all thirty properties once all requests are completed.

The method of this invention may be more easily understood by way of an example. Elements in all figures are used. An individual user at a client access point 202(a) requests property data, as in step 502, pertaining to a single property. The data acquisition system 100 then uses the multi-threaded download job controller 152 to accept the request and forward the request, based upon rules such as priority, to the dynamic scheduling engine 154. The dynamic scheduling engine 154 then determines, as in step 504, the appropriate property information source from among 300(1) to 300(N) and also selects a custom dynamic interface module from among 120(a) to 120(f) previously loaded by the dynamic library loader 151 to use in accessing the appropriate property information source. Using the HTTPS:--.NET credential authentication module 121, the property information source connects, as in step 506, and using the session state caching module 122, the property information source connection is maintained.

The selected custom dynamic interface module then uses dynamic HTML/XML processing module 123 to determine how to retrieve data, e.g., both images and textual data, about the subject property. The information is then passed on to the image/data search and download module 124 for extracting relevant information about the property, as in step 508. Next, the data standardization module 125 may be used to standardize the requested property data as in step 510. The standardized property data is then returned to the dynamic scheduling engine 154 so that the data acquisition system 100 can store the standardized property data in the memory 110, if required in step 514, or transmit the standardized property data in real time to the user at the client access point 203, as in step 518. If the data was not requested in real time by the client access point 202(a), or if the data was a high-volume request originating from a live delivery system such as 202(a), then the data is held in the memory 110 as in step 514, to be passed on to the live delivery system 202(a) or the client access point 203 as in step 516 when the request is complete and ready to be delivered.

It will be apparent to those skilled in the art that the present invention may be practiced without these specifically enumerated details and that the embodiments can be modified so as to provide additional or alternative capabilities. The foregoing description is for illustrative purposes only, and that various changes and modifications can be made to the present invention without departing from the overall spirit and scope of the present invention.

What is claimed is:

1. A computer based apparatus for acquiring and assembling property data, comprising:
a server communicating via a network;
a memory accessible to the server, the memory containing
receiving means executable by the server for receiving a request for property data and
determining means executable by the server for determining, based on the request, a property information source containing the requested property data; and
a custom dynamic interface executable by the server for accessing the property information source via the network, retrieving the requested property data there from, and assembling the retrieved property data in a standard format.

2. The apparatus of claim 1 further comprising a dynamic scheduling engine, contained in the memory and executable by the server, for prioritizing multiple requests for property data.

3. The apparatus of claim 2 wherein the dynamic scheduling engine selects the custom dynamic interface module from among a plurality of custom dynamic interface modules stored in the memory based on the determined property information source.

4. The apparatus of claim 3 wherein the dynamic scheduling engine selects the custom dynamic interface module according to a lookup table, stored in the memory, that cross-references one or more property information sources to one or more custom dynamic interface modules.

5. The apparatus of claim 2 wherein the dynamic scheduling module prioritizes the multiple requests according to availability of a property information source.

6. The apparatus of claim 1 wherein the server stores the assembled property data in the memory in the standard format.

7. The apparatus of claim 1 wherein the server provides the assembled property data to a requestor in the standard format responsive to the request.

8. The apparatus of claim 1 wherein the property information source comprises an online public property information source.

9. The apparatus of claim 1 wherein the determining means determines a plurality of property information sources based on the request, and the custom dynamic interface module accesses the plurality of property information sources.

10. A computer-based method of acquiring and assembling property data comprising:
receiving at a server a request for property data;
determining a property information source based on the request;
accessing the property information source using authentication means;
retrieving the requested property data from the property information source; and
assembling the property data retrieved in a standard format.

11. The method of claim 10 wherein the accessing, retrieving, and assembling steps are affected by the server executing a custom dynamic interface module.

12. The method of claim 10 further comprising selecting, based on the determined property information source, the custom dynamic interface module from among a plurality of custom dynamic interface modules stored in a memory accessible by the server.

13. The method of claim 12 further comprising selecting the custom dynamic interface module according to a lookup table, stored in the memory, that cross-references one or more property information sources to one or more custom dynamic interface modules.

14. The method of claim 10 further comprising prioritizing multiple requests for property data according to property information source availability.

15. The method of claim 10 further comprising storing the assembled property data in a memory in the standard format.

16. The method of claim 10 further comprising providing the assembled property data to a requestor in the standard format responsive to the request.

17. The method of claim 10 further comprising deciding whether the request is a real-time request, and if so
providing the assembled property data to a requestor in the standard format in real time; otherwise
storing the assembled property data in the standard format.

18. The method of claim 17 further comprising, if the request is not a real-time request, forwarding the assembled property data to a requester when the request is complete.

19. The method of claim 10 wherein the determining step determines a plurality of remote property systems based on the request, the accessing step accesses the property information sources using authentication means, and the retrieving step requests property data from the property information sources.

20. A computer-based method of organizing property data comprising:
a dynamic scheduling module for receiving property data from a remote property information system;
a filter module for extracting a portion of the property data to produce relevant property data; and
a data standardization module for formatting the relevant property data into a standard format.
